(19) United States
(12) Patent Application Publication
(10) Pub. No.: US 2023/0140456 A1
(43) Pub. Date: May 4, 2023

(54) PARAMETER SETTING METHOD AND CONTROL METHOD FOR RESERVOIR ELEMENT

(71) Applicant: TDK CORPORATION, Tokyo (JP)

(72) Inventor: Kazuki NAKADA, Tokyo (JP)

(73) Assignee: TDK CORPORATION, Tokyo (JP)

(21) Appl. No.: 17/910,694

(22) PCT Filed: Mar. 26, 2020
(86) PCT No.: PCT/JP2020/013697

§ 371 Date: Sep. 9, 2022

(51) Int. Cl. G06N 7/01; H04R 19/04; H04R 3/00

(52) U.S. Cl. CPC G06N 7/01; H04R 19/04; H04R 3/00; H04R 2201/003

(57) ABSTRACT

A parameter distribution setting method including performs learning based on a gradient learning method in advance such that a mutual information between a probabilistic distribution of an output of a reservoir device and an ideal probabilistic distribution of the output increases, and setting a parameter distribution of parameters defining element derivation in a plurality of elements constituting the reservoir device in a device model for the reservoir device.

### TECHNICAL FIELD

The present invention relates to a parameter setting method and a control method for a reservoir device.

### BACKGROUND ART

A neuromorphic device is a device that imitates the human brain using a neural network. The neuromorphic device artificially imitates a relationship between neurons and synapses in the human brain.

For example, a neuromorphic device includes chips (neurons in the brain) that are hierarchically arranged and transmission means (synapses in the brain) that connect the chips. The neuromorphic device enhances a rate of correct answers to questions by causing the transmission means (synapses) to learn. Learning is to find knowledge which is likely to be used in the future from information, and the neuromorphic device weights data input thereto.

A recurrent neural network is known as a type of neural network. A recurrent neural network can deal with nonlinear time-series data. Nonlinear time-series data is data of which the values change with the elapse of time, and an example thereof is stock prices. Recurrent neural networks can process time-series data by feeding process results in neurons in a subsequent stage back to neurons in a preceding stage.

Reservoir computing is a means for realizing a recurrent neural network. Reservoir computing performs a recursive process by causing signals to interact. For example, reservoir computing imitates an operation of the cerebellum and performs processing of recursive data, conversion of data (for example, conversion of coordinates), and the like.

The concept of physically applying reservoir computing to actual devices has been tried. A device obtained by applying the concept of reservoir computing to an actual device is referred to as a reservoir device in the following description. For example, Non-Patent Document 1 describes a neuromorphic device using spin-torque oscillators (STO) as chips (neurons).

### CITATION LIST

### Non-Patent Literature

### [Non-Patent Document 1]

Jacob Torrejon et al., Nature, Vol. 547, pp. 428-432 (2017)

### [Non-Patent Document 2]

J. Coulombe, M. York, and J. Sylvestre, PLoS One, Vol. 12(6), e0178663 (2017). doi: 10.1371/journal.pone.0178663

### [Non-Patent Document 3]

A. Slavin & V. S. Tiberkevich, IEEE Transactions on Magnetics, Vol. 45(4), pp. 1875-1918 (2009)

### [Non-Patent Document 4]

P. Koprinkova-Hristova et al, International Conference on Artificial Neural Networks. Springer, Berlin, Heidelberg (2011)

### [Non-Patent Document 5]

Susumu SUGIYAMA, Kiyoshi IRIE, Masahiro TOMONAL, Journal of the Robotics Society of Japan, Vol. 33, No. 2, pp. 86-91, 2015

### SUMMARY OF INVENTION

### Technical Problem

The accuracy of fitting an output of a reservoir device to training data varies depending on settings of parameters of the reservoir device. A method of systematically designing parameters of a reservoir device has not been established yet.

The present invention was made in consideration of the aforementioned circumstances and provides a method of systematically designing parameters for defining element derivation of a plurality of elements constituting a reservoir device.

### Solution to Problem

(1) According to a first aspect, there is provided a parameter setting method including: performing pre-training such that a mutual information between an ideal probabilistic distribution of an output of a reservoir device derived from a device model based on characteristics of a plurality of elements constituting the reservoir device and a probabilistic distribution of the output of the reservoir device increases; and setting a parameter distribution of parameters defining derivation in the plurality of elements in the device model.

(2) In the parameter setting method according to the aspect, the device model may be, for example, a model based on spring vibration described in Non-Patent Document 2.

(3) In the parameter setting method according to the aspect, the device model may be, for example, a model based on a generalized nonlinear vibrator model described in Non-Patent Document 3.

(4) According to a second aspect, there is provided a control method for a reservoir device, including: setting the parameter distribution on the basis of the parameter setting method according to the aforementioned aspect; converting the parameter distribution to a characteristic distribution of the reservoir device; and setting characteristics of each of the plurality of elements on the basis of the characteristic distribution.

(5) According to the aspect, there is provided a control method for a reservoir device including a MEMS microphone array including a plurality of MEMS microphones, the control method including: setting the parameter distribution on the basis of the parameter setting method according to the aforementioned aspect; converting the parameter distribution to a distribution of sensitivity characteristics of the MEMS microphone array; and setting sensitivity characteristics of each of the plurality of MEMS microphones on the basis of the distribution of sensitivity characteristics.

(6) According to the aspect, there is provided a control method for a reservoir device including a spin-torque oscillator array including a plurality of spin-torque oscillators, the control method including: setting the parameter distribution on the basis of the parameter setting method according to the aforementioned aspect; converting the parameter distribution to a distribution of resonance characteristics of the spin-torque oscillator array; and setting frequency characteristics of each of the plurality of spin-torque oscillators on the basis of the distribution of resonance characteristics.

### Advantageous Effects of Invention

The parameter setting method according to the aspect provides a method of systematically designing a parameter that defines derivation in a plurality of elements constituting a reservoir device.

### BRIEF DESCRIPTION OF DRAWINGS

FIG. 1 is a conceptual diagram of a neural network that is imitated by a reservoir device according to a first embodiment.

FIG. 2 is a sectional view of an example of a MEMS microphone.

FIG. 3 is a conceptual diagram of a device model when a reservoir device is a MEMS microphone array.

FIG. 4 is a conceptual diagram of reservoir computing for performing pre-training.

FIG. 5A is diagram illustrating a parameter distribution of parameter a calculated by pre-training when an average a of an ideal normal distribution is 0.1 and a variance μ thereof is 0.25.

FIG. 5B is a diagram illustrating a parameter distribution of parameter b calculated by pre-training when an average a of an ideal normal distribution is 0.1 and a variance μ thereof is 0.25.

FIG. 5C is a diagram illustrating an output of a reservoir device and training data when the parameter distributions illustrated in FIGS. 5A and 5B are applied.

FIG. 6A is diagram illustrating a parameter distribution of parameter a calculated by pre-training when an average a of an ideal normal distribution is 0.2 and a variance μ thereof is 0.25.

FIG. 6B is a diagram illustrating a parameter distribution of parameter b calculated by pre-training when an average a of an ideal normal distribution is 0.2 and a variance μ thereof is 0.25.

FIG. 6C is a diagram illustrating an output of a reservoir device and training data when the parameter distributions illustrated in FIGS. 6A and 6B are applied.

FIG. 7A is diagram illustrating a parameter distribution of parameter a calculated by pre-training when an average a of an ideal normal distribution is 0.3 and a variance μ thereof is 0.25.

FIG. 7B is a diagram illustrating a parameter distribution of parameter b calculated by pre-training when an average a of an ideal normal distribution is 0.3 and a variance μ thereof is 0.25.

FIG. 7C is a diagram illustrating an output of a reservoir device and training data when the parameter distributions illustrated in FIGS. 7A and 7B are applied.

FIG. 8 is a circuit diagram of an example of a spin-torque oscillator.

### DESCRIPTION OF EMBODIMENTS

Hereinafter, embodiments will be described in detail with reference to the accompanying drawings. In the drawings referred to in the following description, for the purpose of easy understanding of features of the present invention, featured constituents may be conveniently enlarged, and dimensions, proportions, and the like of the constituents may be different from actual ones. Materials, dimensions, and the like provided in the following description are only exemplary examples, and the present invention is not limited thereto and can be appropriately modified within a range in which advantages of the present invention are achieved.

A reservoir device according to the embodiments is obtained by making processes in reservoir computing into a device. Reservoir computing is an example of a recurrent neural network.

### First Embodiment

(Reservoir Computing)

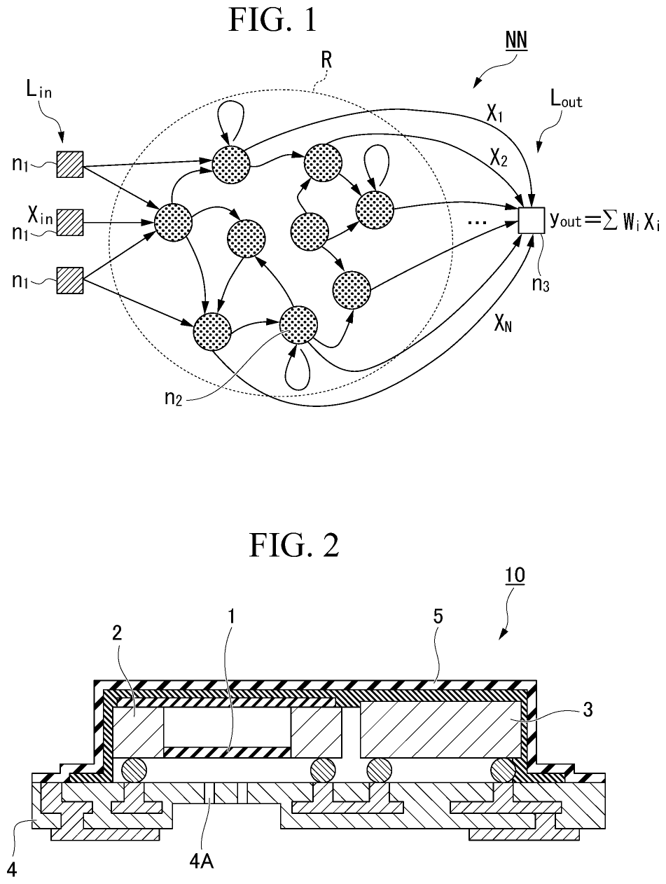

FIG. 1 is a conceptual diagram of a neural network that is imitated by a reservoir device according to a first embodiment. A neural network NN illustrated in FIG. 1 schematically shows the concept of reservoir computing. The neural network NN illustrated in FIG. 1 includes an input layer Lᵢₙ, a reservoir R, and an output layer Lₒᵤₜ. The input layer Lᵢₙ and the output layer Lₒᵤₜ are connected to the reservoir R.

The input layer Lᵢₙ transmits a signal input from the outside to the reservoir R. The input layer Lᵢₙ includes, for example, a plurality of neurons n₁. Input signals input from the outside to the neurons n₁ of the input layer Lᵢₙ are transmitted to the reservoir R.

The reservoir R stores the input signals input from the input layer Lᵢₙ and converts the input signals to other signals. In the reservoir R, signals merely interact, but there is no learning. When input signals interact with each other, the input signals change nonlinearly. That is, the input signals are replaced with other signals while maintaining original information. The input signals change with the elapse of time by interacting with each other in the reservoir R. In the reservoir R, a plurality of neurons n₂ are randomly connected. For example, a signal output from a certain neuron n₂ at time t may return to the original neuron n₂ at time t+1. The neuron n₂ can perform a process in consideration of the signals at time t and time t+1 and recursively process information.

The output layer Lₒᵤₜ outputs a signal from the reservoir R. An output signal output from the output layer Lₒᵤₜ is replaced with another signal while maintaining information of the input signal. An example of the replacement is replacement from an orthogonal coordinate system (x, y, z) to a spherical coordinate system (r, θ, ϕ). The output layer Lₒᵤₜ includes, for example, a plurality of neurons n₃. In the course from the reservoir R to the output layer Lₒᵤₜ, learning is performed. Learning is performed in transmission paths (synapses in the brain) connecting the neurons n₂ of the reservoir R to the neuron n₃ of the output layer Lₒᵤₜ. The output layer Lₒᵤₜ outputs a result of learning to the outside.

(Parameter Setting Method)

A parameter setting method according to this embodiment systematically sets parameters of parts corresponding to the reservoir R. The parameters to be set are parameters for defining characteristic derivation in the plurality of neurons n₁ constituting the reservoir R. The parameter setting method according to this embodiment includes a device model determining step, an ideal probabilistic distribution setting step, and a learning step. These steps will be described below in conjunction with specific examples.

<Application to MEMS Microphone Array>

An exemplary case in which the reservoir device in which the reservoir R in reservoir computing is realized by a physical device is a MEMS microphone array will be provided below. In the MEMS microphone array, MEMS microphones are arranged and are electrically connected to each other. MEMS is an abbreviation of Micro Electronics Mechanical System.

FIG. 2 is a sectional view of an example of a MEMS microphone. A MEMS microphone 10 includes, for example, a vibration membrane 1, a MEMS chip 2, an integrated circuit 3, a substrate 4 including an aperture 4A, and a protective film 5. The vibration membrane 1, the MEMS chip 2, and the integrated circuit 3 are formed on the substrate 4 and are electrically connected to each other. The vibration membrane 1, the MEMS chip 2, and the integrated circuit 3 are protected by the protective film 5. For example, the MEMS microphone 10 converts sound waves to an electrical signal. Sound waves input via the aperture 4A causes the vibration membrane 1 to vibrate. The vibration of the vibration membrane 1 changes, for example, the capacitance of a capacitor in the MEMS chip 2 and is converted to an electrical signal. The integrated circuit 3 includes, for example, an analog-digital converter and outputs an electrical signal in analog.

[Device Model Determining Step]

In the parameter setting method according to this embodiment, first, a device model is determined. The device model is determined on the basis of characteristics of a plurality of elements constituting a reservoir device. When the reservoir device is a MEMS microphone array, the elements constituting the reservoir device are MEMS microphones 10. As described above, each MEMS microphone 10 replaces vibration of the vibration membrane 1 with an electrical signal. When vibration of each vibration membrane 1 is approximated by spring vibration, the MEMS microphone array can be expressed by a model based on spring vibration in which a plurality of springs are connected.

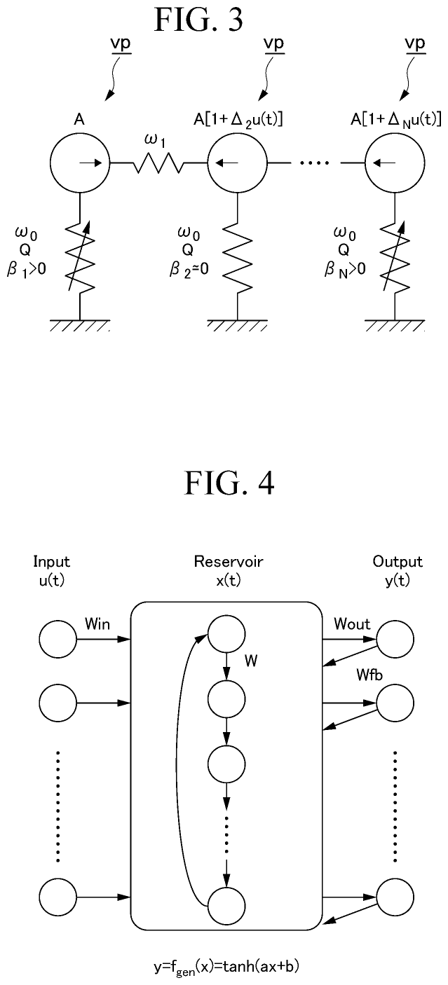

FIG. 3 is a conceptual diagram of a device model when the reservoir device is a MEMS microphone array. In the device model illustrated in FIG. 3, a plurality of vibration points vp are connected by springs. A vibration point vp corresponds to a MEMS microphone 10 in each reservoir element. The device model in which the reservoir device is a MEMS microphone array is expressed by Expression (1).

$$\begin{matrix}[ Math . 1 ] & \\ \frac{{d}^{2} {x}_{i}}{{dt}^{2}} = - \frac{{ω}_{0}}{Q} \frac{{dx}_{i}}{dt} - {ω}_{0}^{2} {x}_{i} - {β}_{i} {x}_{i}^{3} + A [ 1 + {Δ}_{i} {w}_{in} u ] cos ( Ω t ) + {ω}_{1}^{2} [ {x}_{i - 1} - 2 {x}_{i} + {x}_{i + 1} ] & ( 1 )\end{matrix}$$

Here, xᵢ denotes displacement of each vibration point vp. ω₀ is a frequency specific to a spring connected to each vibration point vp and corresponds to vibration of the vibration membrane 1 of each MEMS microphone 10. Q is a quality factor (a Q value). −ω₀/Q-dxᵢ/dt which is the first term of the right side denotes fundamental vibration at the vibration point vp when there is no resistor. −ω₀²·xᵢ which is the second term of the right side denotes attenuation of each vibration point vp and denotes, for example, attenuation of the vibration of the vibration membrane 1 due to air resistance.

βᵢ is a value varying depending on the vibration points vp and corresponds to characteristic derivation in elements of the MEMS microphones 10. −βᵢxᵢ³ which is the third term of the right side denotes nonlinear spring characteristics of each vibration point vp and is vibration varying depending on the MEMS microphones 10. For example, a plurality of MEMS microphones 10 are uneven in performance and −βᵢxᵢ³ is caused due to characteristic derivation in elements. The third term of the right side is a part for amplifying a nonlinear component included in an input signal in the reservoir device.

A[1+Δᵢwᵢₙu] cos(Ωt) which is the fourth term of the right side corresponds to vibration which is caused by a force applied from the outside and vibration which is caused by acoustic waves applied to the corresponding MEMS microphone 10.

ω₁ is a frequency of a spring connecting neighboring vibration points vp. ω₁²[xᵢ₋₁−2xᵢ+xᵢ₊₁] which is the fifth term of the right side denotes vibration corresponding to a frequency of vibration which is caused due to the influence of neighboring vibration points vp on each other and vibration which is caused on the basis of electrical connection between different MEMS microphones 10.

[Ideal Probabilistic Distribution Setting Step]

Subsequently, an ideal probabilistic distribution of an output of the reservoir device is set. An ideal probabilistic distribution of the output is arbitrarily set depending on a task to be solved by reservoir computing. The ideal probabilistic distribution of the output is derived, for example, from the device model. The ideal probabilistic distribution of the output is determined according to characteristics of the device model. The ideal probabilistic distribution of the output is, for example, a normal distribution. For example, a regression problem in which Fourier synthesized waves are approximated by reservoir computing may be considered as a task. Here, the frequency distribution of the output of the reservoir device preferably has the same shape as a frequency distribution included in Fourier synthesized waves (corresponding to a power spectrum) serving as a training signal. When the frequency distribution included in Fourier synthesized waves serving as a training signal is unimodal, the ideal probabilistic distribution of the output of the reservoir device is preferably unimodal. When the frequency distribution included in Fourier synthesized waves serving as a training signal is bimodal, the ideal probabilistic distribution of the output of the reservoir device is set to a mixed normal distribution in order to approximate the bimodal probabilistic distribution.

[Learning Step]

By converting the third term −βᵢxᵢ³ of the right side in the device model to an expression easy to analyze using a Taylor expansion of tanh(x), 3βᵢ(x-tanh(x)) is obtained. The third term of the right side corresponds to element derivation of the MEMS microphones 10 as described above. When parameters for defining derivation are a and b, y=f_{gem}(x)=tanh(ax+b) is an expression including parameters corresponding to derivation in the elements. In the following description, y=f_{gem} (x)=tanh(ax+b) may be referred to as a first function.

Pre-training (for example, see Non-Patent Document 4) is performed using the first function. FIG. 4 is a conceptual diagram of reservoir computing for performing pre-training. Pre-training is performed, for example, by simulation. The first function y=f_{gem}(x)=tanh(ax+b) is extracted portion of the reservoir device that causes nonlinearity, and accuracy of the output of the reservoir device can be enhanced by performing pre-training using the first function.

Pre-training is performed such that a mutual information between the ideal probabilistic distribution of the output and the probabilistic distribution of the output of the reservoir device (the reservoir device including the first function) increases. The initial value of the pre-training can be arbitrarily set and is set to, for example, a uniform random number of [0:1]. Regardless of the initial value of the pre-training, the distribution of parameters a and b approaches a predetermined distribution through the pre-training. The mutual information is an amount indicating a degree of interdependency between two probability variables. When the mutual information between the ideal probabilistic distribution of the output and the probabilistic distribution of the output of the reservoir device increases, the probabilistic distribution of the output of the reservoir device approaches the ideal probabilistic distribution of the output.

Various quantities may be used as the mutual information (for example, see Non-Patent Document 5). For example, the amount of Kullback-Leibler divergence can be used. The amount of Kullback-Leibler divergence is defined as follows.

$$\begin{matrix}[ Math . 2 ] & \\ {D}_{KL} ( \tilde{p} , p ) = \int \tilde{p} ( y ) log ( \frac{\tilde{p} ( y )}{p ( y )} ) dy & \end{matrix}$$

Here, p(y) denotes the probabilistic distribution of an output of the reservoir device and p(y) denotes an ideal probabilistic distribution of the output. For example, p(y) is a normal distribution and is expressed by the following expression. The normal distribution is expressed by a function of an average σ and a variance μ.

$$\begin{matrix}[ Math . 3 ] & \\ {p}_{norm} ( y ) = \frac{1}{σ \sqrt{2 π}} exp ( - \frac{{( y - μ )}^{2}}{2 {σ}^{2}} ) & \end{matrix}$$

The following expressions are obtained by differentiating the amount of Kullback-Leibler divergence with parameters a and b.

$$\begin{matrix}[ Math . 4 ] & \\ \frac{\partial {D}_{KL}}{\partial b} = E ( - \frac{μ}{{σ}^{2}} + \frac{y}{{σ}^{2}} ( 2 {σ}^{2} + 1 - {y}^{2} + μ y ) ) & \end{matrix}$$

$$\begin{matrix}[ Math . 5 ] & \\ \frac{\partial {D}_{KL}}{\partial a} = E ( - \frac{μ x}{{σ}^{2}} + \frac{xy}{{σ}^{2}} ( 2 {σ}^{2} + 1 - {y}^{2} + μ y ) - \frac{1}{a} ) & \end{matrix}$$

Learning for increasing the mutual information is performed, for example, using a gradient learning method. The gradient learning method is one means that calculates an optical value in machine learning. A point at which the differential value is zero corresponds to a part in which the slope of the amount of Kullback-Leibler divergence with respect to parameter a or b is zero. In the part in which the slope is zero, entropy is minimized and the mutual information is maximized. Accordingly, the following relational expression is obtained by modifying the expression such that the differential value is zero.

$$\begin{matrix}[ Math . 6 ] & \\ Δ a = \frac{η}{a} + Δ bx & \end{matrix}$$

$$\begin{matrix}[ Math . 7 ] & \\ Δ b -- η ( - \frac{μ}{{σ}^{2}} + \frac{y}{{σ}^{2}} ( 2 {σ}^{2} + 1 - {y}^{2} + μ y ) ) & \end{matrix}$$

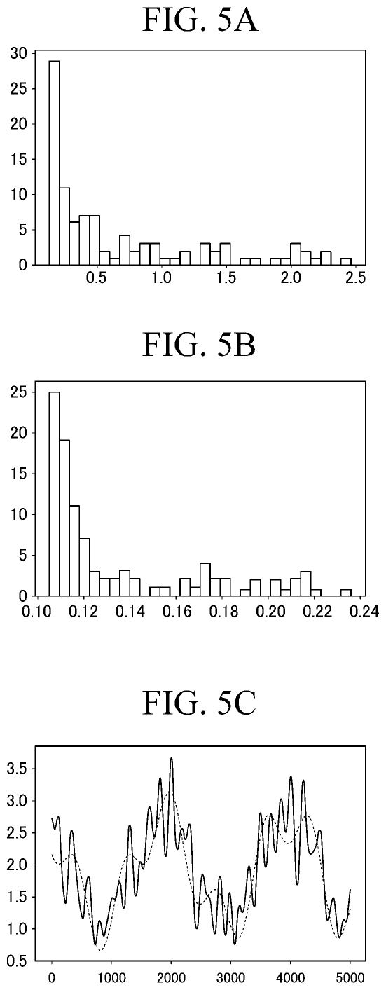

FIG. 5A is diagram illustrating the parameter distribution of parameter a calculated by pre-training when the average σ of an ideal normal distribution is 0.1 and the variance μ thereof is 0.25. FIG. 5B is a diagram illustrating the parameter distribution of parameter b calculated by pre-training when the average σ of an ideal normal distribution is 0.1 and the variance μ thereof is 0.25. FIG. 5C is a diagram illustrating an output of a reservoir device and training data when the parameter distributions illustrated in FIGS. 5A and 5B are applied. The training data is indicated by a dotted line.

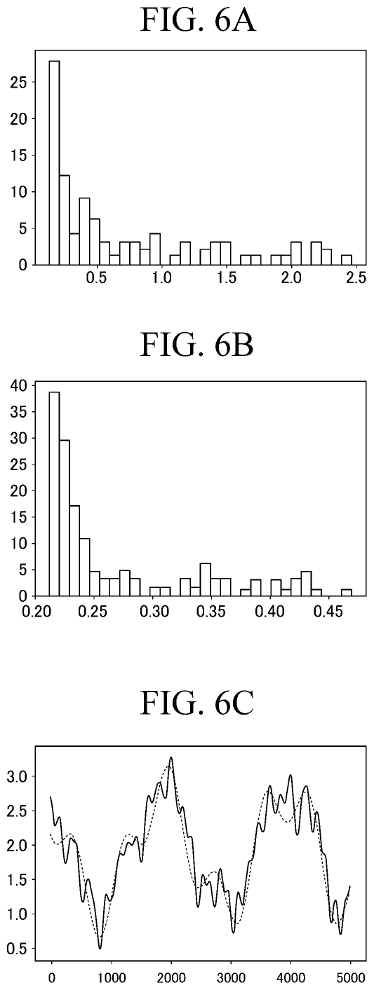

FIG. 6A is diagram illustrating the parameter distribution of parameter a calculated by pre-training when the average σ of an ideal normal distribution is 0.2 and the variance μ thereof is 0.25. FIG. 6B is a diagram illustrating the parameter distribution of parameter b calculated by pre-training when the average σ of an ideal normal distribution is 0.2 and the variance μ thereof is 0.25. FIG. 6C is a diagram illustrating an output of a reservoir device and training data when the parameter distributions illustrated in FIGS. 6A and 6B are applied. The training data is indicated by a dotted line.

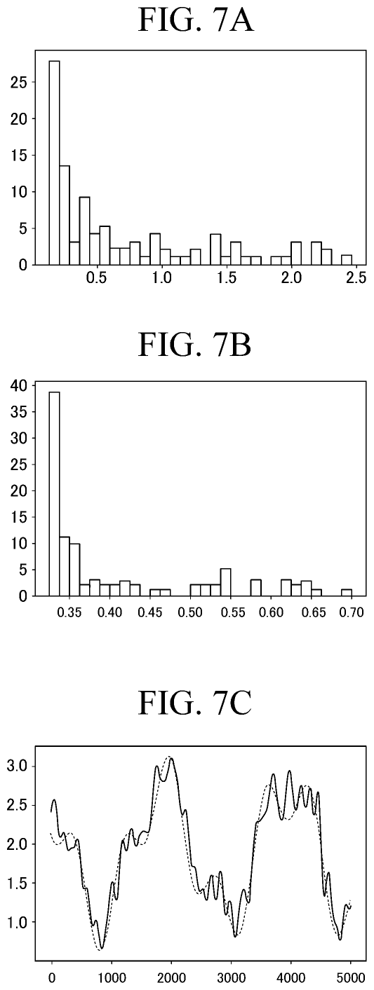

FIG. 7A is diagram illustrating the parameter distribution of parameter a calculated by pre-training when the average σ of an ideal normal distribution is 0.3 and the variance μ thereof is 0.25. FIG. 7B is the diagram illustrating a parameter distribution of parameter b calculated by pre-training when the average σ of an ideal normal distribution is 0.3 and the variance μ thereof is 0.25. FIG. 7C is a diagram illustrating an output of a reservoir device and training data when the parameter distributions illustrated in FIGS. 7A and 7B are applied. The training data is indicated by a dotted line.

Both of the parameter distribution of parameter a and the parameter distribution of parameter b are logarithmic normal distributions. The parameter distribution of parameter a does not change greatly even by changing the average σ of the normal distribution. On the other hand, the parameter distribution of parameter b changes by changing the average σ of the normal distribution. When the average σ of the normal distribution is 0.1, the distribution of parameter b is a logarithmic normal distribution which is maximized at 0.10. When the average σ of the normal distribution is 0.2, the distribution of parameter b is a logarithmic normal distribution which is maximized at 0.20. When the average σ of the normal distribution is 0.3, the distribution of parameter b is a logarithmic normal distribution which is maximized at 0.30. It can be seen that the output of the reservoir device approaches training data and a desired output is obtained using these parameter distributions.

<Application to Spin-Torque Oscillator Array>

A case in which the reservoir device in which the reservoir R in reservoir computing is realized by a physical device is an spin-torque oscillator array will be exemplified below. Even when the elements constituting a reservoir device are spin-torque oscillators, parameters are set in the same way as in the case in which the invention is applied to a MEMS microphone array by changing the device model.

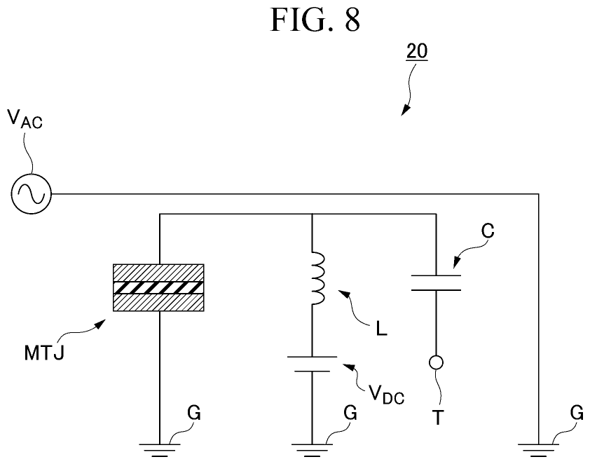

FIG. 8 is a circuit diagram of an example of a spin-torque oscillator. A spin-torque oscillator 20 includes, for example, a magnetoresistive sensor MTJ, an AC power source V_{AC}, a DC power source V_{DC}, an inductor L, a conductor C, and an output terminal T. The magnetoresistive sensor MTJ includes two ferromagnetic layers with a nonmagnetic layer interposed therebetween. Magnetization of one ferromagnetic layer performs a precessional motion with a high-frequency magnetic field generating a high-frequency current which is caused between the AC power source V_{AC} and the ground. Resistance of the magnetoresistive sensor MTJ changes periodically with the precessional motion of magnetization. The DC power source V_{DC} applies a DC current to the magnetoresistive sensor MTJ. A signal which is a product of a resistance value of the magnetoresistive sensor MTJ and a current applied to the magnetoresistive sensor MTJ is output from the output terminal T. Since the resistance of the magnetoresistive sensor MTJ changes periodically, the signal output from the output terminal T also changes periodically.

[Device Model Determining Step]

A device model of a spin-torque oscillator is expressed as a generalized nonlinear oscillator model (Non-Patent Document 3). That is, the device model in which the reservoir device is microphone spin-torque oscillator array is expressed by Expression (2).

$$\begin{matrix}[ Math . 8 ] & \\ \frac{d c}{dt} + i ω ( {\vert c \vert}^{2} ) c + {Γ}_{+} ( {\vert c \vert}^{2} ) c - {Γ}_{-} ( {\vert c \vert}^{2} ) c = f ( t ) & ( 2 )\end{matrix}$$

In Expression (2), c denotes a complex amplitude, and p=|c|² is obtained, where p denotes power of the spin-torque oscillator. The second term of the left side is a term corresponding to a vibration frequency and denotes that the frequency is modulated with the amplitude. The third term of the left side is a dissipation term and corresponds to a damping torque of the spin-torque oscillator. The fourth term of the left side is a term serving as negative resistance and corresponds to a spin-transfer torque of the spin-torque oscillator. The first term of the right side corresponds to an external input and corresponds to, for example, an AC external magnetic field of the spin-torque oscillator.

[Ideal Probabilistic Distribution Setting Step]

The ideal probabilistic distribution setting step is the same as in the case of the MEMS microphone array. For example, an ideal probabilistic distribution of an output is set to a normal distribution. This corresponds to the assumption that the resonance distribution of a spin-torque oscillator is a normal distribution.

[Learning Step]

The learning step is the same as in the case of the aforementioned MEMS microphone array. As derived in Non-Patent Document 3, an oscillation frequency of the spin-torque oscillator corresponding to element derivation is expressed by ω(p)=γ(H₀−4πM₀+8πM₀p) on the basis of Expression (2). Here, H₀ is a parameter corresponding to an effective intensity of a magnetic field, and M₀=|M| is a parameter corresponding to a length of magnetization. In the following description, this expression may be referred to as a second function. The variable p of the second function can be considered to correspond to the variable x of the first function, and the parameters H₀ and M₀ can be considered to correspond to the parameters a and b of the first function. The distribution of parameters and the distribution of resonance characteristics of the spin-torque oscillator array can be converted to each other using this function.

Pre-training is performed using the second function. The pre-training is performed such that the mutual information between the ideal probabilistic distribution of the output and the probabilistic distribution of the output of the spin-torque oscillator serving as a reservoir device increases. An initial value of the pre-training can be arbitrarily set and is set to, for example, a uniform random number of [0:1]. Regardless of the initial value of the pre-training, the distribution of parameters H₀ and M₀ approaches a predetermined distribution through the pre-training. When the mutual information between the ideal probabilistic distribution of the output and the probabilistic distribution of the output of the reservoir device increases, the probabilistic distribution of the output of the reservoir device approaches the ideal probabilistic distribution of the output.

(Control Method for Reservoir Device)

A control method for a reservoir device according to this embodiment includes a step of setting the distribution of parameters, a conversion step of converting the distribution of parameters to a characteristic distribution of elements, and a step of setting characteristics of individual elements on the basis of the distribution of characteristics.

[Conversion Step]

First, a parameter distribution calculated through the aforementioned procedure is converted to a characteristic distribution of elements. When the reservoir device is a MEMS microphone array, the parameter distribution is converted to a distribution of sensitivity characteristics of MEMS microphones. When the reservoir device is a spin-torque oscillator array, the parameter distribution is converted to a distribution of resonance characteristics of spin-torque oscillators.

When parameter a and parameter b are applied to Expression (1) of the device model, sensitivity characteristics of the MEMS microphones are obtained. When parameter a and parameter b are determined, the sensitivity characteristics of the MEMS microphones are determined. Accordingly, the distribution of sensitivity characteristics of the MEMS microphone array is obtained from the parameter distribution.

When parameter H₀ and parameter M₀ are applied to Expression (2) of the device model, resonance characteristics of the spin-torque oscillators are obtained. When parameter H₀ and parameter M₀ are determined, resonance characteristics of the spin-torque oscillators are determined. Accordingly, the distribution of resonance characteristics of the spin-torque oscillator array is obtained from the parameter distribution.

[Element Characteristics Setting Step]

Subsequently, characteristics of individual elements are set on the basis of the obtained characteristic distribution of the reservoir device. For example, when the obtained characteristics are sensitivity characteristics of the MEMS microphone array, the sensitivity characteristics of the MEMS microphones are set. For example, when the obtained characteristics are resonance characteristics of the spin-torque oscillator array, the resonance characteristics of the spin-torque oscillators are set.

The sensitivity characteristics of each MEMS microphone can be set by changing the potential of the MEMS chip 2. When the MEMS chips 2 of the MEMS microphones have different potentials, an electrical signal output by vibration of the vibration membrane 1 differs depending on the MEMS microphones. That is, an input signal (acoustic waves) is converted to a signal varying depending on the elements (MEMS microphones) and is converted to an output which is nonlinear as a whole.

The resonance characteristics of each spin-torque oscillator correspond to a ferromagnetic resonance frequency of the corresponding magnetoresistive sensor MTJ. The ferromagnetic resonance frequency of each magnetoresistive sensor MTJ can be set by an external magnetic field or the like applied to the magnetoresistive sensor MTJ. When the magnetoresistive sensors MTJ have different ferromagnetic resonance frequencies, signals (high-frequency waves) output from the spin-torque oscillators differ. That is, an input signal (high-frequency waves) is converted to a signal varying depending on the elements (spin-torque oscillators) and is converted to an output which is nonlinear as a whole.

When the parameter distribution is set to a uniform distribution, it is necessary to set physical parameters of the elements to a uniform distribution. However, it is difficult to set the physical parameters to a uniform distribution. On the other hand, the parameter distribution required in this embodiment is not uniform (for example, a logarithmic normal distribution). Accordingly, even when elements have production tolerance, a predetermined parameter distribution can be easily set.

With the control method for a reservoir device according to this embodiment, it is possible to systematically set element parameters. By systematically setting the parameters on the basis of pre-training, the output of the reservoir device becomes nonlinear and the accuracy of matching with training data is enhanced.

### REFERENCE SIGNS LIST

1 Vibration membrane
2 MEMS chip
3 Integrated circuit
4 Substrate
4A Aperture
5 Protective film
10 MEMS microphone
20 Spin-torque oscillator
C Conductor
L Inductor
Lᵢₙ Input layer
Lₒᵤₜ Output layer
MTJ Magnetoresistive sensor
n₁, n₂, n₃ Neuron
NN Neural network
T Output terminal
V_{AC} AC power source
V_{DC} DC power source

1. A parameter setting method comprising:
performing pre-training such that a mutual information between an ideal probabilistic distribution of an output of a reservoir device derived from a device model based on characteristics of a plurality of elements constituting the reservoir device and a probabilistic distribution of the output of the reservoir device increases; and
setting a parameter distribution of parameters defining derivation in the plurality of elements in the device model.

2. The parameter setting model according to claim 1, wherein the device model is a model based on spring vibration and is expressed by
$$\frac{{d}^{2} {x}_{i}}{{dt}^{2}} = - \frac{{ω}_{0}}{Q} \frac{{dx}_{i}}{dt} - {ω}_{0}^{2} {x}_{i} - {β}_{i} {x}_{i}^{3} + A [ 1 + {Δ}_{i} {w}_{in} u ] cos ( Ω t ) + {ω}_{1}^{2} [ {x}_{i - 1} - 2 {x}_{i} + {x}_{i + 1} ] .$$

3. The parameter setting model according to claim 1, wherein the device model is a model based on a generalized nonlinear vibrator model and is expressed by
$$\frac{d c}{dt} + i ω ( {\vert c \vert}^{2} ) c + {Γ}_{+} ( {\vert c \vert}^{2} ) c - {Γ}_{-} ( {\vert c \vert}^{2} ) c = f ( t ) .$$

4. A control method for a reservoir device, comprising:
setting the parameter distribution on the basis of the parameter setting method according to claim 1;
converting the parameter distribution to a characteristic distribution of the reservoir device; and
setting characteristics of each of the plurality of elements on the basis of the characteristic distribution.

5. A control method for a reservoir device including a MEMS microphone array including a plurality of MEMS microphones, the control method comprising:
setting the parameter distribution on the basis of the parameter setting method according to claim 2;
converting the parameter distribution to a distribution of sensitivity characteristics of the MEMS microphone array; and
setting sensitivity characteristics of each of the plurality of MEMS microphones on the basis of the distribution of sensitivity characteristics.

6. A control method for a reservoir device including a spin-torque oscillator array including a plurality of spin-torque oscillators, the control method comprising:
setting the parameter distribution on the basis of the parameter setting method according to claim 3;
converting the parameter distribution to a distribution of resonance characteristics of the spin-torque oscillator array; and
setting frequency characteristics of each of the plurality of spin-torque oscillators on the basis of the distribution of resonance characteristics.
